(19) United States
(12) Patent Application Publication
(10) Pub. No.: US 2010/0332768 A1
(43) Pub. Date: Dec. 30, 2010

(54) FLEXIBLE READ- AND WRITE-MONITORED AND BUFFERED MEMORY BLOCKS

(75) Inventors: Jan Gray, Bellevue, WA (US); David Callahan, Seattle, WA (US); Burton Jordan Smith, Seattle, WA (US); Gad Sheaffer, Haifa (IL); Ali-Reza Adl-Tabatabai, San Jose, CA (US); Vadim Bassin, Raanana (IL); Robert Y. Geva, Cupertino, CA (US)

Correspondence Address: WORKMAN NYDEGGER/MICROSOFT, 1000 EAGLE GATE TOWER, 60 EAST SOUTH TEMPLE, SALT LAKE CITY, UT, 84111, US

(73) Assignee: MICROSOFT CORPORATION, Redmond, WA (US)

(21) Appl. No.: 12/493,162

(22) Filed: Jun. 26, 2009

(51) Int. Cl. G06F 12/08

(52) U.S. Cl. 711/146; 711/E12.033

(57) ABSTRACT

A computing system includes a number of threads. The computing system is configured to allow for monitoring and testing memory blocks in a cache memory to determine effects on memory blocks by various agents. The system includes a processor. The processor includes a mechanism implementing an instruction set architecture including instructions accessible by software. The instructions are configured to: set per-hardware-thread, for a first thread, memory access monitoring indicators for a plurality of memory blocks, and test whether any monitoring indicator has been reset by the action of a conflicting memory access by another agent. The processor further includes mechanism configured to: detect conflicting memory accesses by other agents to the monitored memory blocks, and upon such detection of a conflicting access, reset access monitoring indicators corresponding to memory blocks having conflicting memory accesses, and remember that at least one monitoring indicator has been so reset.

### CROSS-REFERENCE TO RELATED APPLICATIONS

This application is related to U.S. patent application Ser. No. ______ filed Jun. 26, 2009, Docket No. 13768.1209, and entitled “PERFORMING ESCAPE ACTIONS IN TRANSACTIONS”, as well as U.S. application Ser. No. ______, filed Jun. 26, 2009, Docket No. 13768.1211, and entitled “WAIT LOSS SYNCHRONIZATION”, as well as U.S. application Ser. No. ______, filed Jun. 26, 2009, DOCKET NO. 13768.1208, and entitled “MINIMIZING CODE DUPLICATION IN AN UNBOUNDED TRANSACTIONAL MEMORY”, as well as U.S. application Ser. No. ______, filed Jun. 26, 2009, Docket No. 13768.1213, and entitled “PRIVATE MEMORY REGIONS AND COHERENCE OPTIMIZATIONS”, as well as U.S. application Ser. No. ______, filed Jun. 26, 2009, Docket No. 13768.1214, and entitled “OPERATING SYSTEM VIRTUAL MEMORY MANAGEMENT FOR HARDWARE TRANSACTIONAL MEMORY”, as well as U.S. application Ser. No. ______, filed Jun. 26, 2009, Docket No. 13768.1215, and entitled “METAPHYSICALLY ADDRESSED CACHE METADATA”. All of the foregoing applications are being filed concurrently herewith and are incorporated herein by reference.

### BACKGROUND

### Background and Relevant Art

Modern multi-thread and multi-processor computer systems have created a number of interesting challenges. One particular challenge relates to memory access. In particular, computer processing capabilities can be increased by using cache memory in addition to regular system memory. Cache memory is high speed memory coupled to a processor and often formed on the same die as the processor. Additionally, cache memory is much smaller than system memory and is made from higher speed memory components than system memory. As such, the processor can access data on the cache memory more quickly than from the regular system memory. Recently or often used data and/or instructions can be fetched from the system memory and stored at the cache memory where they can be reused so as to reduce the access to the slower regular system memory. Data is typically stored in a cache line of a fixed size (e.g. 64 B) where the cache line includes the data of interest and some other data logically surrounding the data of interest. This is useful because often there is a need to operate data related to the data of interest, and that data is often stored logically near the data of interest. Data in the cache can also be operated on and replaced.

As noted, cache memory is typically much smaller than system memory. As such, there is often a need to invalidate cache entries and replace them with other data from the system memory. When a cache entry is invalidated, the data in the cache will typically be sent back to system memory for more persistent storage, especially if the data has been changed. When only a single processor, running a single thread, and a single cache is in use, this can be performed in a relatively straight forward fashion.

However, in multi core systems or multi thread system, each core or thread often has its own local cache. Thus, the same data may be cached at several different locations. If an operation is performed on the data to change the data, then there should be some way to update or invalidate other caches of the data. Such endeavors typically are referred to in the context of cache coherence.

One method of accomplishing cache coherence is to use a coherence bus on which each cache can query other caches and/or can receive messages about other caches. Additionally, each cache line includes a tag entry which specifies a physical address for the data cached at the cache line and a MESI indicator. The MESI indicator is used for implementing the Illinois MESI protocol and indicates a state of data in a cache line. MESI stands for the modified (or dirty), exclusive, shared and invalid states respectively. Because in a cache hierarchy there may be several different copies and versions of a particular piece of data, an indicator is used to indicate the state of data at a particular location. If the indicator indicates that the data is modified, this means that the data at that location was modified by an actor at that location (e.g. a processor or thread coupled to the cache). If the indicator indicates that data is exclusive, this means that other actors at other storage locations may not read or change their copy of the data and that the local actor currently has the sole valid copy of the data across all storage locations. If the indicator indicates that the data is shared, this means that other actors may share this version of the data and this actor may not currently write the data without first acquiring exclusive access. If the data is indicated as invalid, then the data cached at the current location is invalid and is not used.

Thus, in a cache-coherence multiprocessor, a level of data cache that is logically private to one processor (usually level one data cache (L1D$)) may be extended with additional MESI states and behavior to provide cache coherence based detection of conflicting data accesses from other agents, and to locally buffer speculative writes in a private cache such that other agents in the system do not observe speculatively written data until the data's state transitions from speculatively written to globally observed.

Additionally, to implement hardware transactional memory, processor instructions may be implemented to begin, commit, and abort transactions, and to implicitly or explicitly perform transactional load/stores. Often computing systems implement transactional operations where for a given set of operations, either all of the operations should be performed or none of the operations are performed. For example, a banking system may have operations for crediting and debiting accounts. When operations are performed to exchange money from one account to another, serious problems can occur if the system is allowed to credit one account without debiting another account. In a transactional memory system, transactions may also be performed at the abstraction level and granularity of individual memory operations. For example, in this possible code sequence:

void end( ){atomic{−−running;++finished;}}

An atomic block construct guarantees transaction semantics for the statements within. The transactional memory system guarantees that either both the count variable ‘running’ will be decremented and the variable ‘finished’ will be incremented, or neither will be modified. It also guarantees that if another thread observes any effect of the atomic block it can observe every effect of the atomic block, and that even if several atomic blocks are executed concurrently on several threads, the effect is as if each atomic block ran separately, one at a time, in some serialization order. Transactional memory systems maintain data versioning information such that operations can be rolled back if all operations in an atomic set of operations cannot be performed. If all of the operations in the atomic set of operations have been performed, then any changes to data stored in memory are committed and become globally available to other actors for reading or for further operations. Transactional computing can be implemented, in some systems, using specialized hardware that supports transactional memory. In these systems, the MESI state of each cache line may be enhanced to reflect that it represents a line that was transactionally read and/or written. However, in each of the above systems there is no way for software to change or inspect that state.

The subject matter claimed herein is not limited to embodiments that solve any disadvantages or that operate only in environments such as those described above. Rather, this background is only provided to illustrate one exemplary technology area where some embodiments described herein may be practiced.

### BRIEF SUMMARY

One embodiment may be practiced in a computing environment, and includes a computing system including a plurality of threads. The computing system is configured to allow for software to set and test read and write monitors on memory blocks in a cache memory to observe accesses to memory blocks by other agents (such as other threads). The system includes a processor. The processor includes a mechanism implementing an instruction set architecture including instructions accessible by software. The instructions are configured to: set per-hardware-thread, for a first thread, memory access monitoring indicators for a plurality of memory blocks, and test whether any monitoring indicator has been reset by the action of a conflicting memory access by another hardware thread or has been reset spontaneously. The processor further includes; mechanism configured to: detect conflicting memory accesses by other hardware threads to the monitored memory blocks, and upon such detection of a conflicting access, to reset access monitoring indicators corresponding to memory blocks having conflicting memory accesses, and remember that at least one monitoring indicator has been so reset.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description which follows, and in part will be obvious from the description, or may be learned by the practice of the teachings herein. Features and advantages of the invention may be realized and obtained by means of the instruments and combinations particularly pointed out in the appended claims. Features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features can be obtained, a more particular description of the subject matter briefly described above will be rendered by reference to specific embodiments which are illustrated in the appended drawings. Understanding that these drawings depict only typical embodiments and are not therefore to be considered to be limiting in scope, embodiments will be described and explained with additional specificity and detail through the use of the accompanying drawings in which:

FIG. 1A illustrates a cache hierarchy; and

FIG. 1B illustrates details of a data cache with monitoring enabled.

### DETAILED DESCRIPTION

Some embodiments described herein implement an extension of baseline cache-based hardware transactional memory. Some embodiments, through their included features, may add generality, implementation flexibility/agility, and thereby make possible new non-transactional memory uses of the facility. In particular, some embodiments include the ability to, per hardware thread, for a particular thread, using software and a processor instruction set architecture interface, set and test memory access monitoring indicators to determine if blocks of memory are accessed by other agents. An agent is a component of a computer system that interacts with shared memory. For example it may be a CPU core or processor, a thread in a multi-threaded CPU core, a DMA engine, a memory mapped peripheral, etc. For example, software instructions can be used to set a read monitor indicator for a block of cache memory for a particular hardware thread. If another hardware thread writes to the memory block, the read monitor indicator is reset and the loss of read monitor event is accrued into an architected (software visible) status register. Similarly, software instructions can be used to set a write monitor indicator for a block of cache memory for a particular hardware thread. If another hardware thread reads or writes to the memory block, the write monitor indicator is reset and the event is accrued into a status register.

Further utility and generality can be achieved by making the cache line cache coherence MESI state (and in some embodiments extended hardware transactional states indicating a transactional read or a transactional write) accessible via new software instructions. In particular, new instructions may be implemented to test, read, or write monitoring state information.

Some embodiments implement a further generalization, namely to decouple monitoring and buffering from cache based implementations and in particular from cache line size. For example, a processor designer may not be limited to implementing memory blocks that span only a single cache line size, but rather memory blocks may be defined that span multiple and/or partial cache lines. This preserves the processor designer's freedom to adjust cache line sizes across implementations and as we see below enables non-cache implementations.

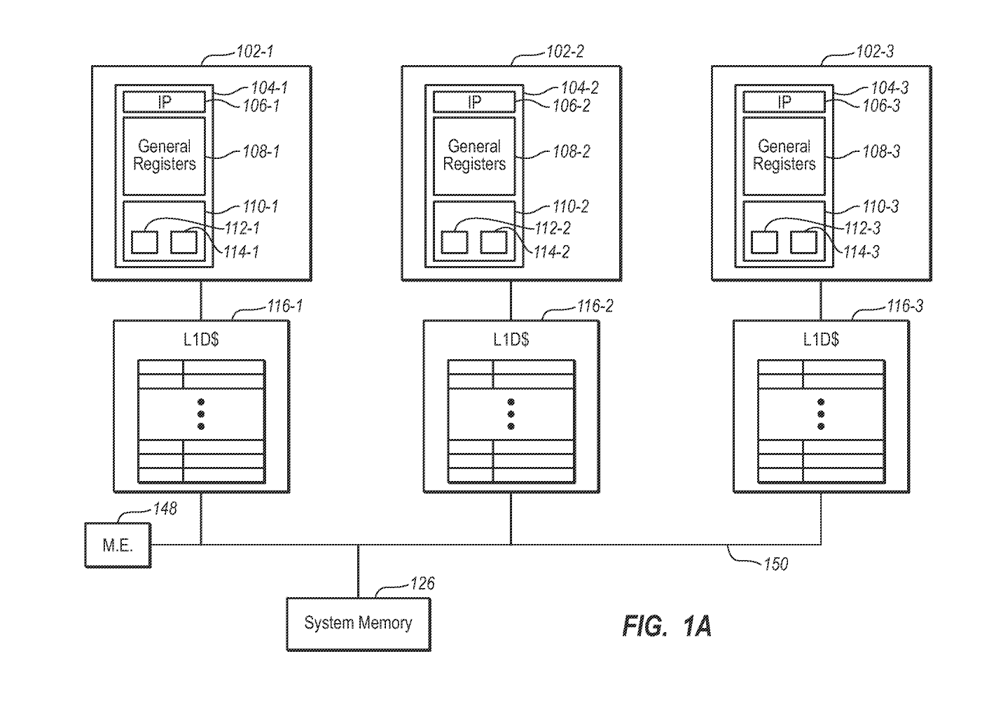

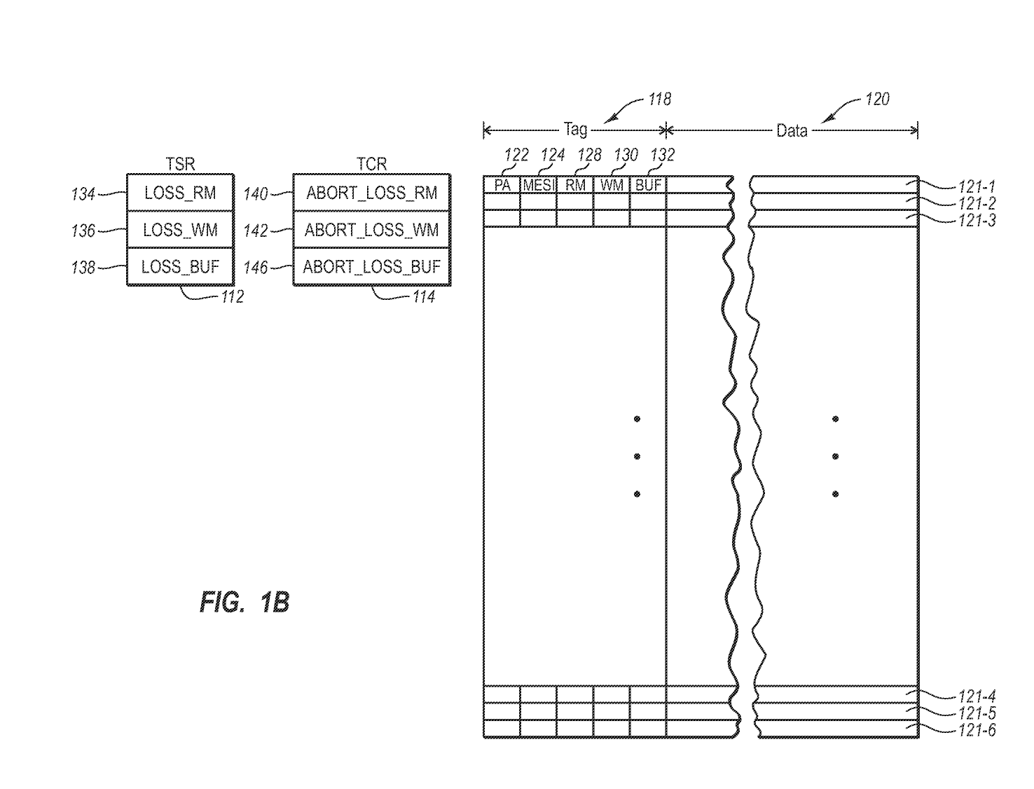

Referring now to FIG. 1A, an example environment is illustrated. FIG. 1A illustrates a plurality of processors 102-1-102-3. When referred to generically herein, the processors may be referred to simply as processor 102. In fact any component referred to using a specific appendix designator may be referred to generically without the appendix designator, but with a general designator to which all specific examples belong. Each of the processors implements one or more threads (referred to generically as 104). In the present example, each of the processors 102-1-102-3 supports a single thread 104-1-104-3 respectively. Each of the threads 104-1-104-3 includes an instruction pointer 106-1-106-3, general registers 108-1-108-3, and special registers 110-1-110-3. Each of the special registers 110-1-110-3 includes a transaction control register (TCR) 112-1-112-3 and a transaction status register (TSR) 114-1-114-3. The functionality of these registers will be explained in more detail below in conjunction with the description of FIG. 1B.

Reference once again to FIG. 1A further illustrates that connected to each processor is a level 1 data cache (L1D$) 116-1, 116-2 and 116-3. Details of a L1D$ are now illustrated with reference to FIG. 1B. FIG. 1B illustrates that a L1D$ 116 includes a tag column 118 and a data column 120. The tag column 118 typically includes an address column 122 and a MESI column 124. The address column 122 includes a physical address for data stored in the data column 120. In particular, as illustrated in FIG. 1A, a computing system generally includes system memory 126. The system memory may be, for example semiconductor based memory, one or more hard-drives and/or flash drives. The system memory 126 has virtual and physical addresses where data is stored. In particular, a physical address identifies some memory location in physical memory, such as system DRAM, whereas a virtual address identifies an absolute address for data. Data may be stored on a hard disk at a virtual address, but will be assigned a physical address when moved into system DRAM.

In the present example, the tag column 118 includes three additional columns, namely a read monitor column (RM) 128, a write monitor column (WM) 130 and a buffer indicator column (BUF) 132. Entries in these columns are typically binary indicators. In particular, a RM entry in the RM column 128 is set on a cache line basis for a particular thread, and indicates whether or not a block of data in the data column 120 should be monitored to determine if the data in the data column 120 is written to by another thread. A WM entry in the WM column 120 is set on a cache line basis for a particular thread, and indicates whether or not the block of data in the data column 120 should be monitored to determine if the data in the data column is read by or written to by another thread. A BUF entry in the BUF column is set on a cache line basis for a particular thread 132, and indicates whether or not data in an entry of the data column 120 is buffered data or if the data is cached data. In particular, the BUF entry can indicate whether a block of data is taken out of cache coherence or not.

Notably, while the RM column 128, the WM column 130, and BUF column 132 are treated as separate columns, it should be appreciated that these indicators could be in fact combined into a single indicator. For example, rather than using one bit for each of the columns, two bits could be used to represent certain combinations of these indicators collectively. In another example, RM column 128, the WM column 130, and BUF column 132 may be represented together with the MESI indicators in the MESI column 124. These seven binary indicators (i.e. M, E, S, I, RM, WM, and BUF) could be represented with fewer bits.

Notably, the indicators in the RM column 128, the WM column 130, and BUF column 132 may be accessible to a programmer using various programming instructions made accessible in a processor's instruction set architecture as will be demonstrated in further detail below.

FIG. 1B further illustrates details of the transaction status register 112 included in the hardware threads 104. The transaction status register 112 accumulates events related to the read monitor indicator, the write-monitor indicator, and the buffer monitor indicator. In particular, the transaction status register 112 includes an entry 134 to accumulate a loss of read monitor, an entry 136 to accumulate a loss of write monitor, and an entry 138 to accumulate a loss of buffering.

Illustrating now an example, a software designer may code instructions that when executed by the thread 104-1 cause a read monitor indicator to be set for a memory block. If another thread writes to the memory block, such access will be noted in the read monitor entry 134.

FIG. 1B illustrates further details of the transaction control register 114. The transaction control register 114 includes entries defining actions that should occur on the loss of read monitor, write-monitor, and/or buffering. In particular, the transaction control register 114 includes an entry 140 that indicates whether or not a transaction should be aborted on the loss of the read monitor, an entry 142 that indicates whether or not a transaction should be aborted on the loss of the write monitor, and an entry 146 that indicates if the transaction should be aborted on the loss of the buffering. Transaction abort is affected by an immediate hardware control transfer (jump) to a software transaction abort handler.

For example, and continuing with the example above where a software designer has coded instructions that when executed by the thread 104-1 cause a read monitor indicator to be set for a memory block, if another thread writes to the memory block, in addition to noting such access in the read monitor entry 134, the read monitor indicator in the read monitor column 128 may be reset.

Specific examples are now illustrated for some embodiments using nomenclature specific to a particular embodiment, but which concepts can be generalized for various implementations. In some embodiments, monitoring block and buffering block extents for data in data entries of the data column 120, sometimes referred to herein as monitoring block size and buffering block size respectively, can vary from implementation to implementation, subject to specific minimums. Embodiments may require software designers to implement software that is required to work correctly with any given sets of sizes subject to these conditions:

As noted, physical memory is logically divided into monitoring blocks. Monitoring blocks are addressed by virtual addresses, but they are associated with a span of physical memory. In one embodiment, the size of each monitoring block is denoted by a size indicator (in the present example referred to as monitoring block size), which is an implementation-defined power of 2. In one embodiment, monitoring blocks are naturally aligned on their size. All valid virtual addresses “A” with the same value ‘floor(A÷ monitoring block size)’ designate the same monitoring block. Monitoring block size may be obtained in one embodiment from instructions implemented in an instruction set architecture for a processor designed for such a purpose. In one embodiment, the monitoring block size for a particular implementation or processor may be obtained from an extended CPU identification instruction such the CPUID instruction used in many common processors. Execution of this instruction may return the monitoring block size for a particular processor implementation or configuration.

As discussed above, per monitoring block, each thread has a private set of monitors—Read Monitor (RM) and Write Monitor (WM)—each per monitoring block granularity region of memory, that software can read and write. Software may set, reset, and test RM and WM for specific monitoring blocks, or reset the bits for all monitoring blocks. Each thread also has a set of Buffering indicators (BUF)—one per buffering block granularity region of memory, that software can read and write. A monitoring block of memory is unmonitored when a monitoring block has all of RM and WM associated with the monitor block set to an initialized or deasserted state (e.g., in one embodiment, equal to 0). A monitoring block is monitored when a monitoring block has either of RM or WM associated with the monitor block set to a set or asserted state (e.g., in one embodiment, equal to 1). A buffering block of memory is unbuffered when a buffering block has BUF associated with the monitor block set to an initialized or deasserted state (e.g., in one embodiment, equal to 0). A buffering block is buffered when a buffering block has BUF associated with the buffering block set to a set or asserted state (e.g., in one embodiment, equal to 1).

Because the memory access monitoring indicators RM, WM, and buffering indicator BUF are implemented in cache memory, whose cache lines churn as various possibly unrelated memory accesses occur, a programmer should assume that these indicators may spontaneously reset to unmonitored and/or unbuffered. In particular, a repurposing of a cache line to make room for a new cache entry will, in some embodiments, cause a monitored state to spontaneously reset to unmonitored and/or cause a buffered state to spontaneously reset to unbuffered. As will be explained in more detail below, after a monitored block has been cleared, an attempt to re-access the block will cause the block to be re-entered into one or more cache lines in an initialized state. A transition from a monitored state to unmonitored generates a monitor loss event, which is captured in the transaction status register 112 and might trigger an ejection or a transaction abortion depending on settings in the transaction control register 114.

As noted above a conflicting access to a monitoring block may occur under a number of different circumstances. For example, a conflicting access may occur when one agent (e.g. a thread) reads data from a monitoring block and/or writes data to a monitoring block, and/or sets a read monitoring indicator for and/or sets a write monitoring indicator for, a monitoring block for which another agent (e.g. another thread) has already set a write monitoring indicator. Another conflicting access may occur when one agent writes data to a monitoring block, and/or sets a write monitoring indicator on a monitoring block for which another agent has already set a read monitor indicator or a write monitor indicator.

A monitor conflict occurs when another agent performs a conflicting access to a monitoring block that a thread has monitored. In one embodiment the monitor state of the monitoring block is reset to unmonitored. A monitor conflict generates a read monitor loss event, or a write monitor loss event as recorded in the transaction status register 112.

In various embodiments, various types of data access may be performed. For example, in one embodiment, a monitored access may be performed, via an explicitly monitored access instruction, in which a data access operation that sets monitoring explicitly as part of execution of the instruction. In such examples data access may implicitly set access monitoring indicators (such as RM, WM) and buffering indicators (such as BUF) as a consequence of a data load or store instruction. Alternatively, unmonitored accesses may be performed. An unmonitored access is one that does not change memory access monitoring indicators. Notably, setting per-hardware-thread memory access monitoring indicators for memory blocks may explicitly set the access monitoring indicators through explicit instructions not associated with data access.

Embodiments may also be implemented similarly to perform data buffering. In this example, rather than implementing monitoring blocks, physical memory is logically divided into buffering blocks. Buffering blocks are addressed by virtual addresses, but they are associated with a span of physical memory. In one embodiment, the size of each buffering blocks is denoted by a size indicator (in the present example referred to as buffering block size), which is an implementation-defined power of 2. In one embodiment, buffering blocks are naturally aligned on their size. All valid virtual addresses “A” with the same value ‘floor(A÷buffering block size)’ designate the same buffering block. Buffering block size may be obtained in one embodiment from instructions implemented in an instruction set architecture for a processor designed for such a purpose. In one embodiment, the buffering block size for a particular implementation or processor may be obtained from an extended CPU identification instruction such the CPUID instruction used in many common processors. Execution of this instruction may return the buffering block size for a particular buffering block (sometimes referred to herein as a bblock).

Per buffering block, each thread has a private instance of a buffering property (BUF) stored in the buffer indicator column 132. The buffering property may be set to visible or buffered. When the buffering property is set to visible (i.e. in the present example, BUF=0) this means all writes to the buffering block's memory range are globally observed. When the buffering property is set to buffered (i.e. in the present example, BUF=1) this means all buffered writes to the buffering block's memory range are locally observed by the agent (e.g. the thread) that issued the writes, but are not globally observed by other agents.

Embodiments may be implemented using an instruction set architecture so that software may set the buffering property BUF for specific buffering blocks, or reset BUF for all buffering blocks.

Reads from a buffered buffering block return the buffered values regardless of the type of read performed, whether monitored or unmonitored. In one embodiment, two different actions can cause the buffering property to transition from asserted to deasserted (e.g. from 1 to 0). The first is when a buffering block-discard discards any writes to the buffering block's memory by the local thread since the buffering property BUF last transitioned from 0 to 1. The second is when a buffering block-commit irrevocably makes such writes to a buffered block globally observable. In one embodiment, only buffering blocks that have both the buffering BUF and write monitor WM properties set may be committed. This affords a simple implementation of hardware transactional memory. All data speculatively written in the transaction are written to buffered memory blocks. A commit instruction is executed that atomically performs buffering-block-commit actions to all buffering blocks of memory so that all data written in the transaction are simultaneously globally observable by other agents. In the event of transaction abort (for example due to a data conflict with another agent as discovered by a loss of read or write monitoring), an abort instruction is executed that atomically performs buffering-block-discard to simultaneously discard all speculatively written data in the transaction, effectively rolling back any effects of the aborted transaction.

A buffering loss occurs when the buffering property BUF of any thread spontaneously resets to 0, performing a buffering block-discard. This may occur, for example, due to cache line eviction or invalidation. Such a transition generates a buffering loss event, which can be accrued by the transaction status register 112 at the entry 138.

A conflicting access to buffered data occurs when one agent writes or sets write monitoring on a buffering block that another agent has buffered. The latter agent incurs buffering loss of that buffering block. The buffering loss even can be accrued by the transaction status register 112 at the entry 138.

Embodiments may include the ability to perform buffered writes and unbuffered writes. A buffered write is a write that sets the buffering property. An unbuffered write is a write that immediately becomes globally visible. If an unbuffered write is performed to a buffering block with buffering property asserted (e.g. BUF=1), the write also updates the buffered copy.

In some embodiments the size of a monitoring block and a buffering block may be related. Specifically: 32 bytes≦buffering block size≦monitoring block size≦4096. Buffering block size is thus large enough to contain any single native data format of the processor. In addition, in such embodiments, buffering block size is guaranteed never to be larger than monitoring block size, which ensures that each buffering block has at most a single containing monitoring block. Finally, buffering block size and monitoring block size may be guaranteed to fit within a single virtual memory system physical page frame, and buffering blocks and monitoring blocks never overlap a physical page frame boundary.

Under this definition, there is now no constraint that monitoring and buffering block sizes correlate to cache sizes. This also enables an implementation that does not use extended MESI cache tags to represent monitors. For example, instead, there could be a new separate monitoring engine (ME) agent 148 illustrated in FIG. 1A. The ME agent 148 may be a peer of the processors (or their caches) on the memory coherence fabric. The memory coherence fabric may be implemented as a bus, ring, mesh, etc. This ME agent 148 would receive set- and test-monitor traffic from the cores on the fabric; perform per-thread/core bulk-clear operations; observe MESI transactions and hence memory range invalidations from other agents; and send loss of monitoring events to hardware threads when such loss occurs.

Illustrating now further details of one example embodiment, an ME agent 148 is an agent (a hardware block that participates in the shared memory system which may or may not be a processor core) that sits on the coherence fabric, observes all coherence traffic, such as reads or exclusive reads for ownership etc. An ME agent 148 may be associated with a single processor, or may be shared by some set of processors. These processors send requests to set- or test-monitoring for an address or address range to the ME agent 148 either on the coherence bus or another appropriate separate interconnect. In one embodiment, the ME agent 148 retains tables of the read- and write-monitored monitoring blocks for each other agent, such as each processor or hardware thread. The tables may contain exact information such as, for each agent, the agent identifier (e.g. a thread identifier, etc.), the list of monitored regions, their base address and size, and type of monitoring that has been established. In other embodiments, the sets of monitored address ranges may be represented using bit vectors or hierarchical bit vectors. In other embodiments, the tables may contain approximate, probabilistic data structures such as bloom filters that summarize inexactly the list, size, and type of monitored regions. In this case, because bloom filters are subject to occasional false positives, this may be manifest in occasional spurious loss of monitoring events. When the ME agent 148 observes an access that conflicts with an RM or WM it is tracking, it kills that monitor, and optionally sends a loss of monitoring signal or message to the affected threads' (e.g. the thread that set the monitor) cores. An ME agent 148 may also have to send loss of monitoring to a thread or core if or when an ME agent 148 has to discard a monitor due to finite ME capacity.

In a multi-socket or high core count many-core processor some embodiments may have an alternative design which replaces the single global ME agent 148 as illustrated above with a collection of ME agents, one for each core or cluster of cores.

In some embodiments there might also be multiple or variable monitor block sizes. For example, one software runtime might monitor some data at a 64 B granularity and another at a 4 KB or 64 KB granularity.

In computer processor technologies, cache line sizes and hence the monitoring and buffering block sizes they manifest may vary from year to year, and/or from chip to chip and/or from system configuration to system configuration. This makes it challenging for deployed software to anticipate and tune for block size via data alignment or other transformations, or to cope with data (like wide vectors) that might span blocks in some implementations. But correctness for implicit or explicit monitored/buffered loads and stores requires that all monitors that overlap the extent of the data item are set and/or tested. Accordingly an aspect of some embodiments is that implicit memory access instructions and explicitly monitoring and/or buffering instructions (each of all operand sizes) correctly set and/or test all blocks that include at least one byte of a monitored or buffered data operand.

In some embodiments there could be instructions to set monitors or test monitoring for larger extents of memory (at monitoring block size granularity). For example, a thread might set write monitoring on 1 MB of its stack in one instruction. This may be impractical in some cache-based monitoring implementations, but can be quite practical in a central monitoring engine system, which might efficiently represent monitored regions using tables of memory region addresses and extents, or bit vectors, or hierarchical bit vectors, or bloom filters.

Another aspect of some embodiments is the use of instructions implemented in an instruction set architecture of a processor to fetch a current implementation's monitoring block size and/or buffering block size. For example, in one embodiment, a cpu identification instruction, such as the CPUID mechanism used in many modern processors may be extended with in the instruction set architecture to include instructions to fetch the current implementation's monitoring block size or buffering block size.

As noted previously, embodiments include an extended instruction set architecture which allows for executing instructions to allow for writing and testing operations to be performed on the read monitors, write monitors, and buffer monitors. These instructions, however, do not need to be only for these operations, but rather may be combined with other operations. The following illustrates a number of instructions that could include functionality for setting, clearing, or testing read and/or write monitors and/or buffers. While specific instruction nomenclature is used, it should be noted that instructions with similar functionality, but with different naming are within the scope of the contemplated embodiments.

MOVMD—Is an instruction that copies metadata into a storage location. The MOVMD instruction converts the memory data address to a thread-private memory metadata address. It then loads or stores at the metadata address the byte, word, doubleword, or quadword of metadata to or from a register Details of this instruction in included in U.S. patent application Ser. No. ______, titled “Metaphysically Addressed Cache Metadata” filed concurrently herewith, which is incorporated herein by reference in its entirety.

Physical memory may be logically divided into metadata blocks. Metadata blocks are addressed by virtual addresses. In one embodiment, the size of each metadata block is denoted by a size indicator (in the present example referred to as metadata block size), which is an implementation-defined power of 2. In one embodiment, metadata blocks are naturally aligned on their size. All valid virtual addresses “A” with the same value ‘floor(A÷metadata block size)’ designate the same metadata block. Metadata block size may be obtained in one embodiment from instructions implemented in an instruction set architecture for a processor designed for such a purpose. In one embodiment, the metadata block size for a particular implementation or processor may be obtained from an extended CPU identification instruction such the CPUID instruction used in many common processors. Execution of this instruction may return the metadata block size for a particular processor implementation or configuration.

The MOVMD instruction may load or store metadata for an address that may span a plurality of metadata blocks. In some embodiments, these metadata blocks may decay to their initialized state independently.

MOVXB is an instruction that moves data where the move is explicitly buffered. In particular, it performs a buffered write of the data to memory, atomically establishing buffering on all buffering blocks that contain bytes of the data operand. For example, with reference to FIG. 1B, in addition to performing a data write, this instruction also causes a BUF entry at 132 to be set for all buffering blocks that contain bytes of the data operand. In one embodiment, when not in a transaction, MOVXB performs as an unbuffered store and does not change the buffering and monitoring state of the accessed monitoring block or buffering block. However, embodiments may also be implemented where buffering is performed whether in a transaction or not.

MOVXM is an instruction that moves data where the move is explicitly monitored. In particular, a MOVXM load instruction performs a monitored read, establishing read monitoring on all monitoring blocks that contain bytes of the data operand. For example, with reference to FIG. 1B, in addition to performing a data read, this instruction also causes a RM entry at 128 to be set. In one embodiment, when not in a transaction, MOVXM performs a regular load and does not change the read monitoring state of the accessed monitoring block. However, embodiments may be implemented where MOVXM sets the read monitoring state of the accessed monitoring block whether in a transaction or not. The MOVXM store instruction performs a monitored write, establishing write monitoring on all monitoring blocks that contain bytes of the data operand. For example, with reference to FIG. 1B, in addition to performing a data write, this instruction also causes a WM entry at 130 to be set. In one embodiment, when not in a transaction, MOVXM performs a regular store and does not set the write monitoring state of the accessed monitoring block. However, embodiments may be implemented where MOVXM sets the write monitoring state of the accessed monitoring block whether in a transaction or not.

MOVXU is an instruction that moves data where the move is explicitly unmonitored and un-buffered. MOVXU instruction performs an unmonitored and unbuffered load or store, independently of whether or not the hardware is in a transaction state. An access does not change any monitoring or buffering properties of accessed monitoring blocks or buffering blocks. A MOVXU load can be used to read from a buffered buffering block and returns the buffered values. A MOVXU store immediately becomes globally visible. In some embodiments if it is performed to data within a buffering block with the buffer set (e.g. BUF=1), the write also updates the buffered copy.

STRM is an instruction that sets read monitoring. This instruction begins read monitoring the specified monitoring block(s). Read monitoring is set for all monitoring blocks that contain bytes of the data operand.

STWM is an instruction that sets write monitoring. This instruction begins write monitoring the specified monitoring block(s). Write monitoring is set for all monitoring blocks that contain bytes of the data operand.

TESTBF is an instruction that tests for buffer. This instruction tests if the set of buffering blocks that contain bytes of the data operand all have buffering set.

TESTRM is an instruction that tests for read monitoring. This instruction tests if the set of monitoring blocks that contain bytes of the data operand all have read monitoring set.

TESTWM is an instruction that tests for write monitoring. This instruction tests if the set of all monitoring blocks that contain bytes of the data operand all have write monitoring set.

TINVD is an instruction that discards buffered data and clears all monitoring on monitoring blocks that contain the target location specified with the instruction.

TINVDA Is an instruction that discards buffered data and clears all monitoring on MBLKs that contain the target location specified with the instruction. This instruction also generates appropriate loss of read monitoring, loss of write monitoring, and/or loss of buffering events accumulating them into the TSR 112 if any monitor or buffer indicators were previously set on the target memory locations.

Embodiments of the present invention may comprise or utilize a special purpose or general-purpose computer including computer hardware, as discussed in greater detail below. Embodiments within the scope of the present invention also include physical and other computer-readable media for carrying or storing computer-executable instructions and/or data structures. Such computer-readable media can be any available media that can be accessed by a general purpose or special purpose computer system. Computer-readable media that store computer-executable instructions are physical storage media. Computer-readable media that carry computer-executable instructions are transmission media. Thus, by way of example, and not limitation, embodiments of the invention can comprise at least two distinctly different kinds of computer-readable media: physical storage media and transmission media.

Physical storage media includes RAM, ROM, EEPROM, CD-ROM or other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry or desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to physical storage media (or vice versa). For example, computer-executable instructions or data structures received over a network or data link can be buffered in RAM within a network interface module (e.g., a “NIC”), and then eventually transferred to computer system RAM and/or to less volatile physical storage media at a computer system. Thus, it should be understood that physical storage media can be included in computer system components that also (or even primarily) utilize transmission media.

Computer-executable instructions comprise, for example, instructions and data which cause a general purpose computer, special purpose computer, or special purpose processing device to perform a certain function or group of functions. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, and the like. The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. In a computing environment, a computing system comprising a plurality of threads, the computing system being configured to allow for monitoring and testing memory blocks in a cache memory to observe accesses on memory blocks by other agents, the system comprising:
a processor, the processor comprising:
a mechanism implementing an instruction set architecture comprising instructions accessible by software configured to:
set per-hardware-thread, for a first thread, memory access monitoring indicators for a plurality of memory blocks; and
test whether any monitoring indicator has been reset by the action of a conflicting memory access by another hardware thread; and
a mechanism configured to:
detect conflicting memory accesses by other hardware threads to the monitored memory blocks; and
upon such detection of a conflicting access, to reset access monitoring indicators corresponding to memory blocks having conflicting memory accesses, and remember that at least one monitoring indicator has been so reset.

2. The apparatus of claim 1, wherein setting per-hardware-thread memory access monitoring indicators for a plurality of memory blocks comprises explicitly setting the access monitoring indicators through explicit instructions.

3. The apparatus of claim 1, wherein setting per-hardware-thread memory access monitoring indicators for a plurality of memory blocks comprises implicitly setting the access monitoring indicators as a consequence of at least one of a data load or store instruction.

4. The apparatus of claim 1, wherein detecting conflicting memory accesses by other hardware threads to the monitored memory comprises detecting write accesses to a memory block from other hardware threads when a write monitor indicator has been set.

5. The apparatus of claim 1, wherein detecting conflicting memory accesses by other hardware threads to the monitored memory comprises detecting read or write accesses to a memory block from other hardware threads when a read monitor has been set.

6. The apparatus of claim 1, wherein the processor instruction set architecture also comprises one or more instructions to interrogate a particular monitoring indicator memory block size.

7. The apparatus of claim 1, wherein memory block size is specific to a particular processor implementation or configuration, but may vary across a compatible family of processor implementations or configurations.

8. The apparatus of claim 1, wherein memory block size is fixed;

9. The apparatus of claim 1, wherein memory block size is a power of 2 bytes.

10. The apparatus of claim 1, wherein memory block extents are naturally aligned such that a first memory block starts at virtual address 0 and each subsequent memory block follows consecutively from the preceding memory block.

11. The apparatus of claim 1, wherein memory block size is not equal to a processor implementation's cache line size.

12. The apparatus of claim 1, wherein there is no restriction on the alignment of data operands for instructions to set or test memory access monitoring indicators or on instructions to load or store data that may also set or test memory access monitoring indicators.

13. The apparatus of claim 1, wherein the processor further comprises functionality, when executing a load or store instruction storing any datum of any width, to set memory access monitoring indicators on a memory block or plurality of memory blocks that contain any bytes of the datum.

14. The apparatus of claim 1, wherein the processor further comprises functionality, when executing a set memory access monitoring indicator instruction for a datum of any width, to set memory access monitoring indicators on a memory block or plurality of memory blocks that contain any bytes of the datum.

15. The apparatus of claim 1, wherein the processor further comprises functionality, when executing a test memory access monitoring indicator instruction for a datum of any width, to test that all of the desired memory access monitoring indicators on a memory block or plurality of memory blocks that contain any bytes of the datum are set.

16. In a computing environment, a method of setting read or write monitoring or buffer monitoring on a cache line, the method comprising:
executing a software instruction to set per-hardware-thread, for a first thread, memory access monitoring indicators for a plurality of memory blocks;
executing a software instruction to test whether any monitoring indicator has been reset by the action of a conflicting memory access by another hardware thread;
detecting conflicting memory accesses by other hardware threads to the monitored memory blocks; and
upon such detection of a conflicting access, resetting access monitoring indicators corresponding to memory blocks having conflicting memory accesses, and remembering that at least one monitoring indicator has been so reset.

17. The method of claim 16, wherein the software instruction to set per-hardware-thread, for a first thread, memory access monitoring indicators for a plurality of memory blocks is an instruction implemented in an instruction set architecture for a processor and further causes a data write at the memory blocks.

18. The method of claim 16, wherein the software instruction to set per-hardware-thread, for a first thread, memory access monitoring indicators for a plurality of memory blocks sets a write monitor for detecting conflicting writes.

19. The method of claim 16, wherein the software instruction to set per-hardware-thread, for a first thread, memory access monitoring indicators for a plurality of memory blocks sets a read monitor for detecting conflicting reads or writes.

20. In a computing environment including a plurality of threads, a computing system comprising:
a processor, the processor comprising:
a mechanism implementing an instruction set architecture comprising instructions accessible by software configured to:
using processor level instructions, set per-hardware-thread, for a first thread, memory access monitoring indicators for a plurality of memory blocks; and
using processor level instructions, test whether any monitoring indicator has been reset by the action of a conflicting memory access by another hardware thread; and
a monitoring engine configured to detect conflicting memory accesses by other hardware threads to the monitored memory blocks;
a transaction control register, wherein the transaction control register includes indicators that can be set or cleared by software instructions, the indicators indicating if an abort operation should occur on conflicting memory accesses; and
a transaction status register, wherein the transaction status register is configured to remember that at least one monitoring indicator has been reset.
